(19) United States
(12) Patent Application Publication
(10) Pub. No.: US 2011/0100125 A1
(43) Pub. Date: May 5, 2011

(54) ACCELERATION SENSOR

(75) Inventor: Kenta SATO, Kamiina (JP)

(73) Assignee: SEIKO EPSON CORPORATION, Tokyo (JP)

(21) Appl. No.: 12/913,256

(22) Filed: Oct. 27, 2010

(30) Foreign Application Priority Data
Oct. 29, 2009 (JP) 2009-249531
Oct. 22, 2010 (JP) 2010-237957

(51) Int. Cl. G01P 15/10

(52) U.S. Cl. 73/514.29

(57) ABSTRACT

An acceleration sensor includes: a sensitive element having a vibrating beam, base ends located at both ends of the vibrating beam, and excitation electrodes which are formed on a surface of the vibrating beam; a supporting section connected to each of the base ends in order to support the sensitive element; a connecting section which is provided between one of the base ends and the supporting section so as to extend from the one base end in the opposite direction to the one base end on the same axis as the vibrating beam and which has a thin section formed along the longitudinal direction of the vibrating beam; and a spindle section which is disposed at both sides of the sensitive element in the width direction in a state of being connected to the one base end and extends toward the other base end side along the longitudinal direction.

The entire disclosure of Japanese Patent Application Nos: 2009-249531, filed Oct. 29, 2009 and 2010-237957, filed Oct. 22, 2010 are expressly incorporated by reference herein.

### BACKGROUND

1. Technical Field

The present invention relates to an acceleration sensor for detecting acceleration using a piezoelectric vibrating reed as a sensitive element in order to measure or detect the movement or vibration of an object, a posture change, and the like.

2. Related Art

Generally, a piezoelectric resonator has a characteristic in which a resonant frequency changes with the size of a stress applied. In particular, it is known that a piezoelectric resonator of a bending vibration mode has a high rate of frequency change with respect to the applied stress compared with other vibration modes. Especially, it is reported that a dual tuning fork resonator with a structure including two parallel vibrating beams and a base end connected to each of both ends thereof has a frequency characteristic of high Q value and good linearity, is excellent in repeatability and hysteresis, and has a fast response speed (for example, see “Masao Kurihara et al., ‘Quartz Pressure Sensor Using Dual Tuning Fork Resonator’, Toyo Communication Equipment Technical Report, Toyo Communication Equipment Co., Ltd., 1990, No. 46, p. 1-8”).

For this reason, various acceleration sensors using a dual tuning fork piezoelectric resonator have been developed. For example, an acceleration sensor is known in which one base end of a dual tuning fork piezoelectric vibrating reed is supported on a fixed member, the other base end is supported on a movable member which is a spindle, and a force in a compressive or tensile direction acts on the piezoelectric vibrating reed from both the ends when the movable member is displaced in the application direction by the acceleration so that the frequency is increased or decreased (for example, see JP-A-2008-170203). In this acceleration sensor, the piezoelectric vibrating reed, the fixed member, and the movable member are formed as separate members and these members are fixed with an adhesive or the like so as to be unified. Accordingly, since the number of components and the number of assembly steps are increased, the assembly work is complicated.

In order to solve such a problem, there is known an accelerometer that includes a pendulum type rotational mass, which is a spindle connected to a base through a hinge, and two vibrating strips, that is, two dual tuning fork piezoelectric vibrating reeds disposed at both the sides and that is formed by processing a quartz crystal piece as a single piece, in which one base end of the vibrating reed is fixed to the base and the other base end is fixed to the rotational mass, using a photolithography technique (see JP-A-1-302166). In this accelerometer, when the rotational mass rotates around the hinge by the acceleration in the in-plane direction, a tensile stress acts on one piezoelectric vibrating reed and a compressive stress acts on the other piezoelectric vibrating reed to shift frequencies. Accordingly, a difference between these frequencies is measured.

Similarly, there is known an acceleration sensor that includes a supporting section, an inertial mass section which is a spindle section, and a force transducer formed by a dual tuning fork piezoelectric vibrating reed and that is formed by a single crystal substrate in which both ends of a piezoelectric vibrating reed are connected to the supporting section and the inertial mass section respectively (see U.S. Pat. No. 5,165,279). FIG. 6A schematically shows the entire configuration of this acceleration sensor 1.

A force transducer, that is, a piezoelectric vibrating reed 2, is a dual tuning fork piezoelectric vibrating reed including two parallel vibrating beams 3 and base ends 4 and 5 located at both ends of the vibrating beams 3 in the longitudinal direction. One base end 4 is connected to a supporting section 6, and the other base end 5 is connected to an inertial mass section, that is, a spindle section 7. The supporting section 6 extends both sides of the piezoelectric vibrating reed 2 up to the vicinity of the other base end 5 along the longitudinal direction and is connected to the spindle section 7. The supporting section 6 and the spindle section 7 are connected to each other through a flexible thin wall section 8 by forming a groove, which extends in a direction perpendicular to the longitudinal direction of the vibrating beam, at the top surface side of the supporting section 6 and the spindle section 7. The other base end 5 and the spindle section 7 are connected to each other through a flexible thin wall section 9 by similarly forming a groove, which extends in a direction perpendicular to the longitudinal direction of the vibrating beam, at the bottom surface side of the other base end 5 and the spindle section 7.

When acceleration acts downward in the normal direction of the principal surface as indicated by the arrow in FIG. 6B, the spindle section 7 rotates downward around the axis HA passing through the center of the thin wall section 8. By this operation, the thin wall section 9 which connects the spindle section 7 with the base end 5 of the piezoelectric vibrating reed 2 is displaced to a position TA′ when the axis TA passing through the center has rotated downward around the axis HA, as shown in FIG. 6C. As a result, the force in the tensile direction acts on the vibrating beam 3 from the base end 5, and the frequency of the piezoelectric vibrating reed 2 is increased.

On the contrary, when acceleration acts upward in the normal direction of the principal surface of the spindle section 7 as indicated by the arrow in FIG. 6D, the spindle section 7 rotates upward around the axis HA passing through the center of the thin wall section 8. By this operation, the thin wall section 9 is displaced to a position TA′ when the axis TA passing through the center has rotated upward around the axis HA, as shown in FIG. 6E. As a result, the force in the compressive direction acts on the vibrating beam 3 from the base end 5, and the frequency of the piezoelectric vibrating reed 2 is decreased.

The acceleration sensor disclosed in U.S. Pat. No. 5,165,279 is more advantageous than the acceleration sensor which needs two piezoelectric vibrating reeds as disclosed in JP-A-1-302166 because not only the size of acceleration but also the direction can be determined with one piezoelectric vibrating reed. However, the acceleration sensor disclosed in U.S. Pat. No. 5,165,279 has the following problems.

Generally, it is preferable to form a mass which receives the action of inertial force by acceleration, that is, a spindle section in a large size in order to raise the sensitivity in an acceleration sensor. In the case of the acceleration sensor processed by photo-etching one piezoelectric wafer or a chip as disclosed in U.S. Pat. No. 5,165,279, it is important to further increase the area of a spindle section in order to improve the sensor sensitivity.

In the acceleration sensor disclosed in U.S. Pat. No. 5,165,279, the spindle section is provided at the opposite side to the vibrating beam from the base end of the piezoelectric vibrating reed. Accordingly, if the planar size of the spindle section is increased, the planar size of the entire acceleration sensor is increased. For this reason, it is difficult to realize an improvement in the sensitivity and a reduction in the size simultaneously. Moreover, in the case of a sensitive element formed by a piezoelectric vibrating reed, the length of a vibrating beam is determined on the basis of the resonant frequency. Accordingly, when the package dimension is determined in advance, the degree of freedom in design of a spindle section is low. In this case, a sufficient sensitivity may not be obtained.

Moreover, in the acceleration sensor disclosed in U.S. Pat. No. 5,165,279, recesses should be separately etched on the top and bottom surfaces of a piezoelectric substrate in order to form a thin wall section between each of the spindle section and the supporting section and the base end. For this reason, since a working process is complicated and troublesome, the number of manufacturing steps is increased. As a result, there is a problem in that costs increase.

### SUMMARY

An advantage of some aspects of the invention is to make it possible to measure the acceleration with high precision and high sensitivity by increasing the degree of freedom in the design of a spindle section in an acceleration sensor with a sensitive element which has a vibrating beam of a bending vibration mode, preferably, without making the manufacturing process complicated or increasing the number of manufacturing steps.

Another advantage of some aspects of the invention is to provide an acceleration sensor capable of detecting the acceleration in two axial directions perpendicular to each other.

According to an aspect of the invention, an acceleration sensor includes: a first sensitive element having a first vibrating beam, base ends located at both ends of the first vibrating beam in the longitudinal direction, and excitation electrodes which are formed on a surface of the first vibrating beam in order to excite the first vibrating beam in a bending vibration mode; a supporting section connected to each of the base ends in order to support the first sensitive element; a connecting section which is provided between one of the base ends and the adjacent supporting section so as to extend from the one base end in the opposite direction to the one base end on the same axis as the first vibrating beam and which has a thin wall section formed along the longitudinal direction of the first vibrating beam; and a spindle section which is disposed at both sides of the sensitive element in the width direction in a state of being connected to the one base end and extends toward the other base end side along the longitudinal direction.

The spindle section elastically deforms downward or upward with a portion connected with the base end as a point of support when acceleration acts downward or upward in the normal direction of the principal surface. This generates a rotation moment corresponding to the size and the direction of acceleration with the center of gravity of the spindle section as a force applied point and the thin wall section as a point of action, so that a compressive stress or a tensile stress acts along the longitudinal direction of the vibrating beam from the base end.

According to the aspect of the invention, since the spindle section is provided from one base end of the sensitive element toward the other base end side, a distance from the center of gravity of the spindle section to the point of action can be freely set without being restricted to the length of the vibrating beam. Accordingly, for equal acceleration, a large force can be made to act from the spindle section by the vibrating beam. In addition to this, since a point of action of the force transmitted from the spindle section to the vibrating beam is set in the thin wall section of the connecting section, the acceleration can be directly and efficiently transmitted from the spindle section to the vibrating beam. As a result, in the invention, the sensitivity of the acceleration sensor can be significantly improved on.

In addition, in the acceleration sensor according to the aspect of the invention, the sensitive element is fixed and supported at two points of both the ends. Accordingly, the loss of vibration is small compared with a known structure in which a piezoelectric vibrating reed is supported at one point of the one end. As a result, since the CI value of the piezoelectric vibrating reed which forms the sensitive element is reduced and the Q value is increased, a frequency variation is reduced. Accordingly, high resolution for an acceleration sensor can be obtained.

In one embodiment of the invention, the acceleration sensor may further include: second and third sensitive elements symmetrically disposed at both sides of the spindle section in the width direction; and second and third supporting sections for supporting the second and third sensitive elements, respectively. The second and third sensitive elements may have second and third vibrating beams extending in parallel to the first vibrating beam along the adjacent spindle section, respectively. The second and third vibrating beams may be connected to the adjacent spindle section at the base end located opposite the connecting section in the longitudinal direction and may be connected to the second and third supporting sections at the base end located at a side of the connecting section in the longitudinal direction, respectively.

If acceleration acts on the spindle section in the in-plane direction, the spindle section elastically deforms in the left and right direction with a portion connected with the base end and the second and third supporting sections as each point of support. Then, the vibrating beams of the second and third sensitive elements similarly deform in the left and right direction with portions connected with the second and third supporting sections as the point of support. As a result, since a compressive stress or a tensile stress is generated along the longitudinal direction of the vibrating beams in the second and third sensitive elements, the frequencies change. In this case, since the vibrating beams of the second and third sensitive elements are symmetrically bent to vibrate, the frequency variations are opposed as positive and negative values when the acceleration is in the width direction of the vibrating beam but are equal when the acceleration is in the longitudinal direction of the vibrating beam. Therefore, the acceleration in the width direction of the vibrating beam can be detected from the difference between the frequency variations of the second and third sensitive elements.

In addition, a frequency variation based on a component of acceleration in the width direction of the vibrating beam, which is included in the frequency variation of the first sensitive element, can be detected on the basis of the frequency variations of the second and third sensitive elements. Therefore, since the influence of the component of acceleration in the width direction of the vibrating beam is eliminated from the frequency variation of the first sensitive element, measurement can performed with higher precision by correcting the acceleration in the normal direction of the principal surface of the spindle section.

Moreover, from the frequency variations of the second and third sensitive elements, it can be determined that acceleration is in the longitudinal direction of the vibrating beam when the frequency variations are equal and the acceleration is in the other direction when the frequency variations are not equal.

In another embodiment of the invention, in the acceleration sensor described above, a first sensitive element may be formed by a dual tuning fork piezoelectric vibrating reed which has the two first vibrating beams extending in parallel. As described above, it is known that the dual tuning fork piezoelectric vibrating reed has a frequency characteristic of high Q value and good linearity, is excellent in repeatability and hysteresis, and has a fast response speed. Accordingly, the acceleration sensor can be made with higher precision and higher sensitivity.

Instill another embodiment of the invention, in the acceleration sensor described above, the supporting section may be formed by one supporting frame which surrounds the outside of the spindle section and the sensitive element. Accordingly, an acceleration sensor device packaged in an integral structure can be easily manufactured by laminating and bonding a base plate and a lid plate on top and bottom surfaces of the supporting frame, respectively, in the acceleration sensor. In particular, since a plurality of acceleration sensors can be simultaneously processed in one wafer similar to the base plate and the lid plate, a plurality of acceleration sensor devices can be collectively manufactured using a known wafer processing technique and assembly technique. As a result, manufacturing costs can be significantly reduced.

### BRIEF DESCRIPTION OF THE DRAWINGS

The invention will be described with reference to the accompanying drawings, wherein like numbers reference like elements.

FIG. 1A is a plan view of an acceleration sensor according to a first embodiment of the invention.

FIG. 1B is a partially enlarged sectional view of a connecting section taken along the line I-I of FIG. 1A.

FIGS. 2A and 2B are partially enlarged sectional views near a connecting section showing an operational state of a sensitive element in the first embodiment.

FIGS. 3A and 3B are partially enlarged sectional views near a connecting section showing another operational state of the sensitive element in the first embodiment.

FIG. 4A is a plan view of an acceleration sensor in a modification of the first embodiment.

FIG. 4B is a partially enlarged sectional view of a connecting section taken along the line IV-IV of FIG. 4A.

FIG. 5A is a plan view of an acceleration sensor according to a second embodiment of the invention.

FIG. 5B is a partially enlarged sectional view of a connecting section taken along the line V-V of FIG. 5A.

FIG. 6A is a plan view of an acceleration sensor in the related art.

FIGS. 6B to 6E are partially enlarged sectional views showing the operational state.

### DESCRIPTION OF EXEMPLARY EMBODIMENTS

Hereinafter, preferred embodiments of the invention will be described in detail with reference to the accompanying drawings. Moreover, in the accompanying drawings, the same or similar constituent components are denoted by the same or similar reference numerals.

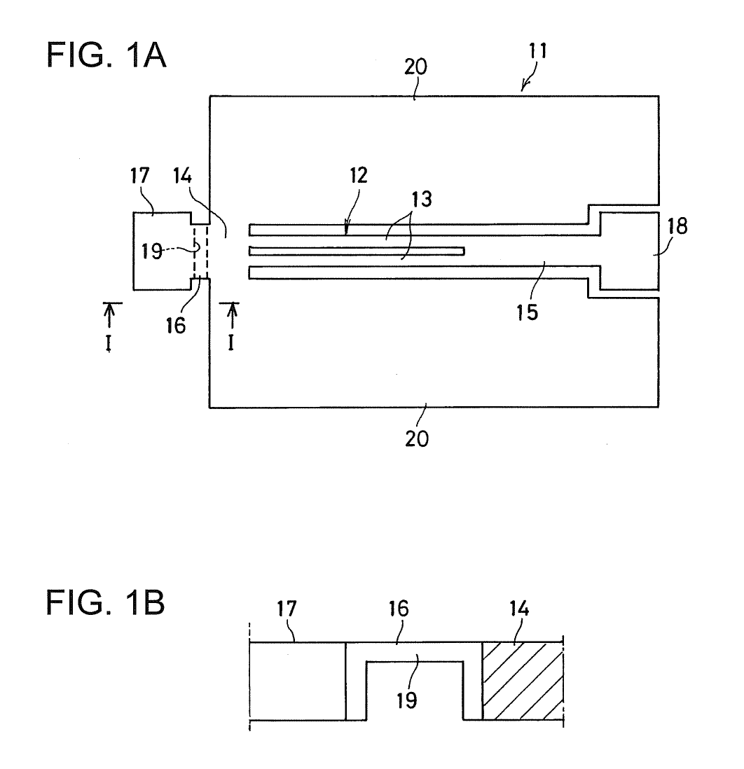

FIG. 1A schematically shows an acceleration sensor according to a first embodiment of the invention. An acceleration sensor 11 of the present embodiment has a dual tuning fork piezoelectric vibrating reed 12 as a sensitive element. The dual tuning fork piezoelectric vibrating reed 12 has a pair of vibrating beams 13 extending in parallel and base ends 14 and 15 located at both ends of the vibrating beams 13 in the longitudinal direction. One base end 14 is connected to a supporting section 17, which is located at the opposite side to the vibrating beam, through a connecting section 16, and the other base end 15 is directly connected to a supporting section 18 located at the opposite side to the vibrating beam. Excitation electrodes (not shown) are formed in a desired pattern on the surface of each vibrating beam. If a predetermined voltage is applied to the excitation electrodes, the vibrating beams are bent to vibrate in a direction moving closer to or away from each other within a plane.

In the connecting section 16, a thin wall section 19 with a fixed thickness is provided by forming a groove at the bottom surface side over the entire width, as shown in FIG. 1B. Approximately rectangular spindle sections 20, which are disposed at both sides of the piezoelectric vibrating reed 12 in the width direction, are integrally connected to the base end 14 at the side where the connecting section 16 is provided. The spindle sections 20 are formed so as to be symmetrical with respect to the piezoelectric vibrating reed 12, and extend from the base end 14 to the tip of the supporting section 18 along the longitudinal direction of the piezoelectric vibrating reed.

The acceleration sensor 11 of the present embodiment can be easily manufactured from a quartz crystal wafer using a known photo-etching technique or the like. In addition to quartz crystal, known piezoelectric materials, such as lithium tantalate and lithium niobate, may be used.

The acceleration sensor 11 is used in a state where both the supporting sections 17 and 18 are fixed to a mount, such as a base, with an adhesive and the piezoelectric vibrating reed is two-point-supported at both the ends. In this state, the spindle sections 20 elastically deform downward or upward with a portion connected with the base end 14 as a point of support if acceleration acts downward or upward in the normal direction of the principal surface. Accordingly, the rotation moment corresponding to the size and the direction of acceleration is generated with the center of gravity of the spindle section as a force applied point and the thin wall section 19 as a point of action. This makes a compressive stress or a tensile stress act on the base end 14 and the vibrating beam 13 along the longitudinal direction.

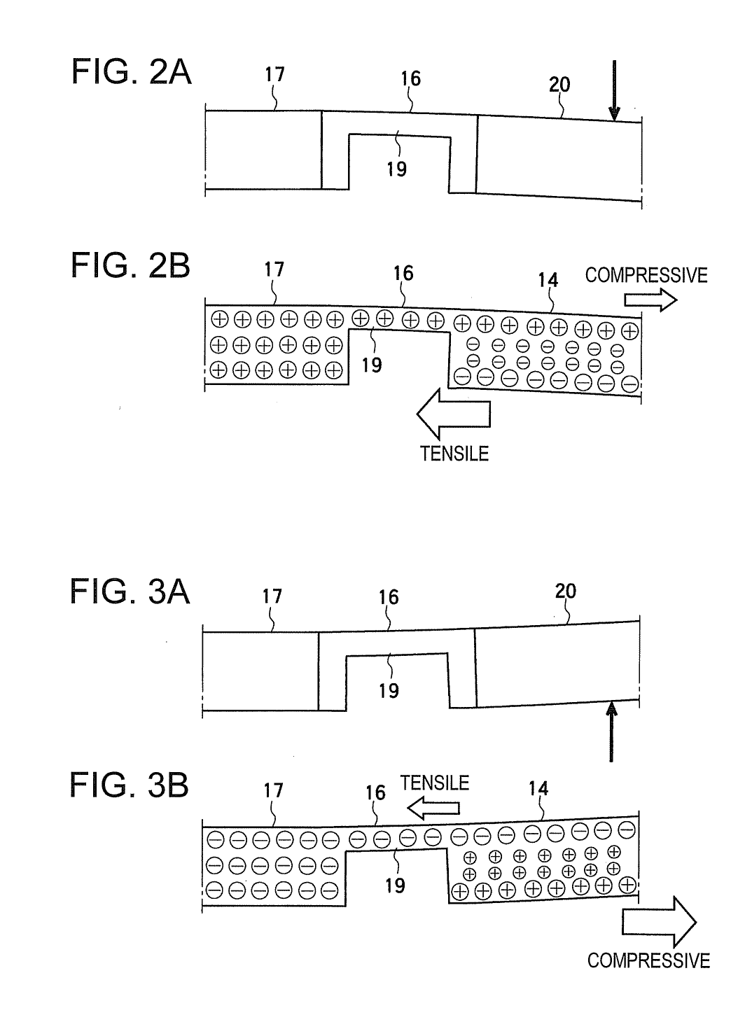

FIG. 2A shows an operational state when acceleration acts downward on the spindle sections 20. In this case, the thin wall section 19 of the connecting section 16 is bent so as to be convex upward. In this state, how the stress acted on the piezoelectric vibrating reed 12 was simulated using a limited element method. The result is shown in FIG. 2B.

In FIG. 2B, a + mark added to O indicates the generation of a compressive stress, and a − mark added to O indicates the generation of a tensile stress. As can be seen from FIG. 2B, in the case of downward acceleration, the compressive stress and the tensile stress are separately distributed at the top and bottom surface sides of the vibrating beam 13, respectively. As a result, it was also confirmed from the result of actual frequency measurement that the frequency of the piezoelectric vibrating reed 12 changed in a direction of dropping with a resonant frequency f0 when the acceleration was 0 as a reference.

FIG. 3A shows an operational state when acceleration acts upward on the spindle sections 20. In this case, the thin wall section 19 of the connecting section 16 is bent so as to be convex downward. In this state, how the stress acted on the piezoelectric vibrating reed 12 was similarly simulated using the limited element method. The result is shown in FIG. 3B.

As can be seen from FIG. 3B, in the case of upward acceleration, the tensile stress and the compressive stress are separately distributed at the top and bottom surface sides of the vibrating beam 13, respectively. As a result, it was also confirmed from the result of actual frequency measurement that the frequency of the piezoelectric vibrating reed 12 changed in a direction of rising similarly with the resonant frequency f0 as a reference.

In another embodiment, a thin wall section which similarly functions as the thin wall section 19 in the embodiment described above can be provided by forming a groove at the top surface side of the connecting section 16. In this case, the frequency of the piezoelectric vibrating reed 12 changes in the opposite direction to the case of the embodiment described above regarding the direction of acceleration acting on the spindle section 20.

Although the spindle sections 20 are provided from one base end 14 of the piezoelectric vibrating reed 12 to the vicinity of the tip of the supporting section 18 along the longitudinal direction in the present embodiment, the spindle sections 20 may be further extended exceeding the range in the invention. Thus, by providing the spindle sections 20 from one base end of the piezoelectric vibrating reed toward the other base end side, a distance from the center of gravity of the spindle section, that is, a force applied point of the spindle section to the point of action can be freely set to be larger than that in the related art without being restricted to the length of the vibrating beam 13. Accordingly, for equal acceleration, a larger force than in the related art can be easily made to act from the spindle section by the piezoelectric vibrating reed 12.

In addition, the point of action of the force transmitted from the spindle sections 20 to the piezoelectric vibrating reed 12 is set in the thin wall section 19 of the connecting section 16 connected to the opposite side of the base end 14 to the vibrating beam 13. Accordingly, acceleration applied to the spindle section can be directly and efficiently transmitted to the piezoelectric vibrating reed 12 which is a sensitive element. As a result, the sensitivity of the acceleration sensor 11 can be significantly improved on.

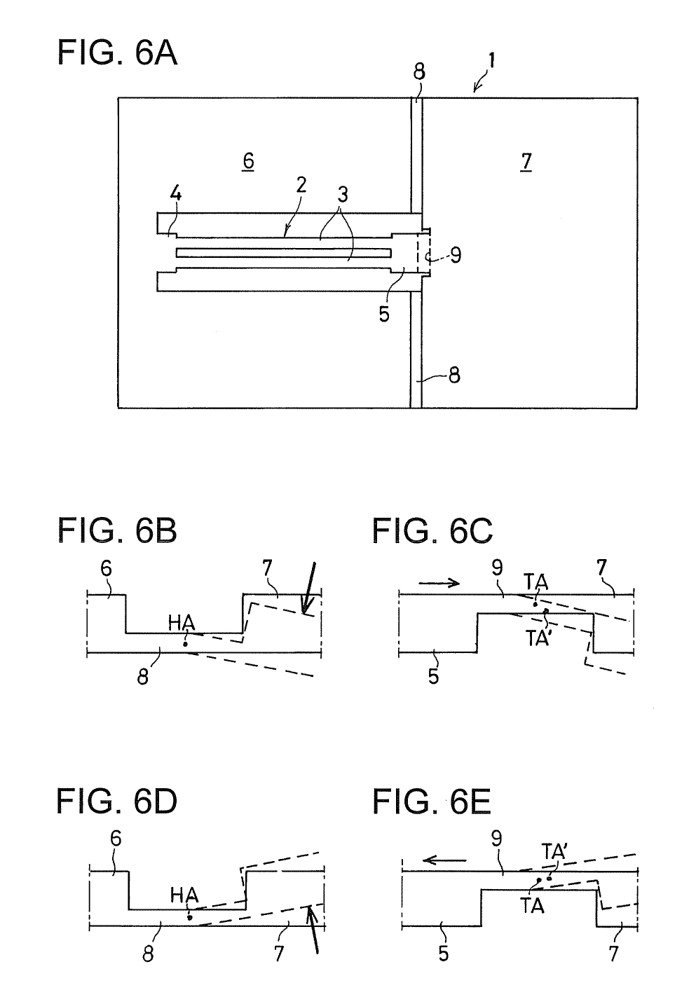

For example, the sensitivity when the chip size was set to 5.5×3.5×0.1 mm in the acceleration sensor of the first embodiment shown in FIGS. 1A and 1B was simulated using a known analysis model. As a result, the sensitivity of 200 ppm/G could be obtained. For the purpose of comparison, the sensitivity when the chip size was the same in an acceleration sensor based on a known technique shown in FIG. 6A was simulated using the same analysis model. As a result, the sensitivity was 40 ppm/G. Thus, in the present embodiment, the sensitivity could be improved by five times.

Particularly in the acceleration sensor 11 of the present embodiment, the piezoelectric vibrating reed 12 is fixed and supported at two points of both the ends as described above. Accordingly, the loss of vibration is small compared with a structure in which a piezoelectric vibrating reed is supported at one point of the one end like the known example shown in FIG. 6A. As a result, since the CI value of the piezoelectric vibrating reed 12 is reduced and the Q value is increased, a frequency variation is reduced. Accordingly, the piezoelectric vibrating reed 12 can obtain high resolution as an acceleration sensor.

Moreover, according to the embodiment of the invention, as a recessed groove processed on the surface of the acceleration sensor 11, there is only the groove for defining the thin wall section 19 of the connecting section 16. Therefore, in the machining process of the acceleration sensor, it is sufficient to form a recessed groove on only one side. Then, compared with a case where the known acceleration sensor described above is processed, the number of manufacturing steps can be reduced and the operation can be simplified. As a result, the manufacturing costs can be reduced.

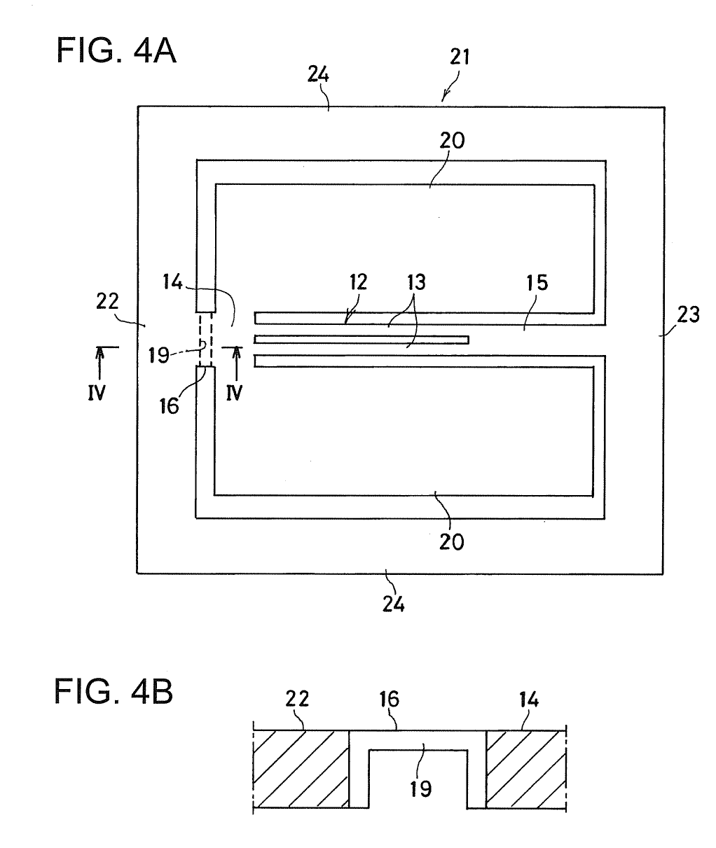

FIGS. 4A and 4B show a modification of the acceleration sensor according to the first embodiment of the invention. In an acceleration sensor 21 of the present embodiment, a supporting section 22, which is connected to one base end 14 of the dual tuning fork piezoelectric vibrating reed 12 through the connecting section 16, and the supporting section 18 at the opposite side, which is directly connected to the other base end 15, extend around the piezoelectric vibrating reed 12 and the spindle sections 20 to be connected to each other. As a result, a rectangular frame section 24 is formed.

The acceleration sensor 21 can be easily packaged in an acceleration sensor device with an integral structure by fixing both the supporting sections 22 and 23 on a mount of a base plate with an adhesive or the like and laminating and bonding a base plate and a lid plate on top and bottom surfaces of the frame section 24. It is advantageous to form the base plate and the lid plate with the same piezoelectric material as the acceleration sensor 21 or a material with approximately the same coefficient of thermal expansion as the piezoelectric material because there is no possibility that the base plate and the lid plate will be influenced by the change of environmental temperature when the acceleration sensor 21 is used.

In addition, the plurality of acceleration sensors 21 can be simultaneously processed in one wafer. Similarly, it is well known that a plurality of base plates and a plurality of lid plates can be simultaneously processed in one wafer. Accordingly, using a known wafer processing technique and assembly technique, a plurality of packaged acceleration sensor devices can be collectively manufactured. As a result, manufacturing costs can be significantly reduced.

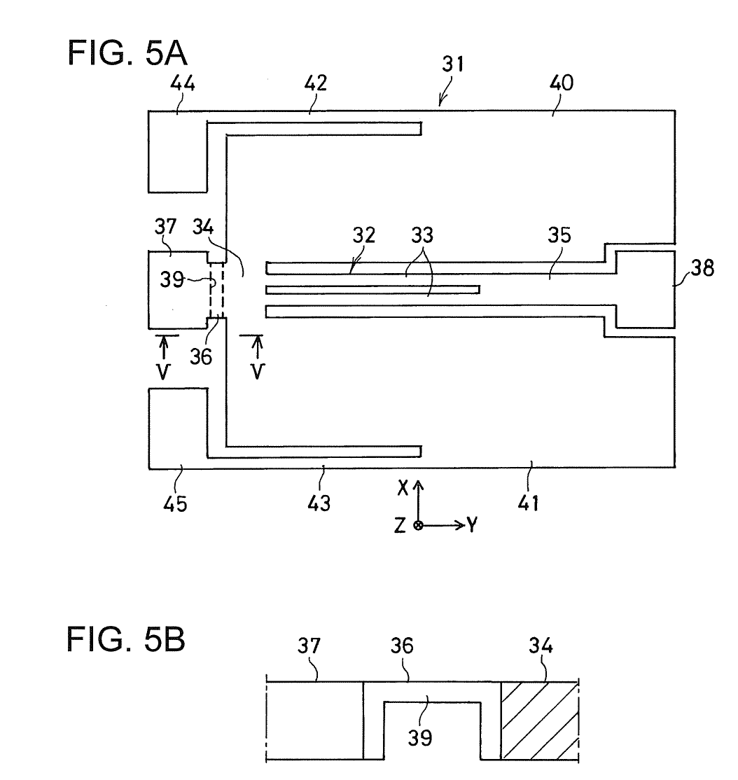

FIGS. 5A and 5B show an acceleration sensor according to a second embodiment of the invention. Similar to the first embodiment, in an acceleration sensor 31 of the present embodiment, a first dual tuning fork piezoelectric vibrating reed 32 as a sensitive element has a pair of vibrating beams 33 extending in parallel and base ends 34 and 35 located at both ends of the vibrating beams 33 in the longitudinal direction. One base end 34 is connected to a supporting section 37, which is located at the opposite side to the vibrating beam, through a connecting section 36, and the other base end 35 is directly connected to a supporting section 38 located at the opposite side to the vibrating beam. Excitation electrodes (not shown) are formed in a desired pattern on the surface of each vibrating beam. If a predetermined voltage is applied to the excitation electrodes, the vibrating beams are bent to vibrate in a direction of moving closer to or away from each other within a plane.

In the connecting section 36, a thin wall section 39 with a fixed thickness is provided by forming a groove at the bottom surface side over the entire width, as shown in FIG. 5B. Approximately rectangular spindle sections 40 and 41, which are disposed at both sides of the first piezoelectric vibrating reed 32 in the width direction, are integrally connected to the base end 34 at the side where the connecting section 36 is provided. The spindle sections 40 and 41 are formed so as to be symmetrical with respect to the first piezoelectric vibrating reed 32, and extend from the base end to the tip of the supporting section 38 along the longitudinal direction of the first piezoelectric vibrating reed.

Moreover, in the acceleration sensor 31 of the present embodiment, second and third piezoelectric vibrating reeds 42 and 43 serving as sensitive elements are provided at both sides of the spindle sections 40 and 41 in the width direction along the outside lines. Each of the second and third piezoelectric vibrating reeds 42 and 43 has one vibrating beam extending in parallel to the vibrating beam 33 of the first piezoelectric vibrating reed 32. The one ends of the second and third piezoelectric vibrating reeds 42 and 43 are connected to approximately the middle positions of the spindle sections 40 and 41 in the longitudinal direction, and the other ends are connected to second and third supporting sections 44 and 45 disposed at both sides of the supporting section 37 in the width direction. The second and third piezoelectric vibrating reeds 42 and 43 are provided so as to be symmetrical with respect to the first piezoelectric vibrating reed 32, and the supporting sections 44 and 45 are provided so as to be symmetrical with respect to the first piezoelectric vibrating reed 32. Excitation electrodes are formed in a desired pattern on the surface of the vibrating beam of each of the second and third piezoelectric vibrating reeds 42 and 43. If a predetermined voltage is applied to the excitation electrodes, the vibrating beams are bent to vibrate in a direction of moving closer to or away from each other with the spindle sections 40 and 41 interposed therebetween within a plane.

The acceleration sensor 31 is used in a state where the supporting section 37, 38, 44, and 45 are fixed to a mount, such as a base, with an adhesive, the first piezoelectric vibrating reed 32 is two-point-supported at both the ends, and each of the second and third piezoelectric vibrating reeds 42 and 43 is one-point-supported at the one end. In this state, each of the spindle sections 40 and 41 elastically deform downward or upward with a portion connected with the base end 34 as a point of support if acceleration acts downward or upward in the normal direction of the principal surface of the spindle sections 40 and 41, that is, in the z direction. Accordingly, the rotation moment corresponding to the size and the direction of acceleration is generated with the center of gravity of the spindle section as a force applied point and the thin wall section 39 as a point of action. This makes a compressive stress or a tensile stress act on the vibrating beam 33 and the base end 34 of the first piezoelectric vibrating reed 32 along the longitudinal direction.

Similar to the case of the first embodiment described with reference to FIGS. 2A to 3B, if downward acceleration acts on the spindle sections 40 and 41, the frequency of the first piezoelectric vibrating reed 32 changes in a direction of dropping with the resonant frequency f0 when the acceleration is 0 as a reference. On the contrary, if upward acceleration acts on the spindle sections 40 and 41, the frequency of the first piezoelectric vibrating reed 32 changes in a direction of rising similarly with the resonant frequency f0 as a reference.

If acceleration in the in-plane direction, that is, in the x-axis direction acts on the spindle sections 40 and 41, the spindle sections 40 and 41 elastically deform in the left and right directions with portions connected with the base end 34 and the second and third supporting sections 44 and 45 as each point of support, then, the vibrating beams of the second and third piezoelectric vibrating reeds 42 and 43 are similarly bent in the left and right directions with portions connected with the second and third supporting sections 44 and 45 as the point of support. As a result, a compressive stress or a tensile stress is similarly generated along the longitudinal direction. Also in the first piezoelectric vibrating reed 32, the compressive stress or the tensile stress is generated in the base end 34 by the deformation of each spindle section and is transmitted to the vibrating beam 33.

When acceleration g (gx, gy, gz) acts on the spindle sections 40 and 41 at the temperature T, ΔF1, ΔF2, and ΔF3 are expressed in the following expressions assuming frequency variations occurring in the first to third piezoelectric vibrating reeds 32, 42, and 43, which are vibrating at a predetermined resonant frequency, are ΔF1, ΔF2, and ΔF3, respectively.

ΔF1=ΔF1_{gx}+ΔF1_{gy}+ΔF1_{gz}+ΔF_{T}

ΔF2=ΔF2_{gx}+ΔF2_{gy}+ΔF2_{gz}+ΔF_{T}

ΔF3=ΔF3_{gx}+ΔF3_{gy}+ΔF3_{gz}+ΔF_{T}

Here, ΔF_{T} is a temperature component term.

Since the second and third piezoelectric vibrating reeds 42 and 43 are symmetrically provided as described above and are bent to vibrate in a direction of moving closer to or away from each other, ΔF2_{gy}=ΔF3_{gy}, ΔF2_{gz}=ΔF3_{gz}, and ΔF2_{gx}=−ΔF3_{gx} are satisfied. Accordingly, ΔF2−ΔF3=2ΔF2_{gx} is satisfied. Since ΔF1_{gx} can be calculated from this, the x-direction component gx of the acceleration g can be detected.

Moreover, in the first piezoelectric vibrating reed 32, the detection axis is a Z direction. Accordingly, the temperature component ΔF_{T} and the ΔF1_{gx} and ΔF1_{gy} components of ΔF1 are error factors. However, since ΔF1_{gx} can be calculated as described above, the influence of the x-direction component gx of the acceleration g can be corrected. Therefore, acceleration in the z direction can be measured with higher precision.

Moreover, in the second and third piezoelectric vibrating reeds 42 and 43, frequency variations based on the acceleration in the x direction are opposed as positive and negative values as described above, but frequency variations based on the acceleration in the y direction are equal. Accordingly, since ΔF2=ΔF3 is satisfied only when acceleration is only in the y direction, it is possible to determine whether the direction of acceleration is in a y direction or x and z directions by comparing the frequency variations.

The invention is not limited to the embodiments described above, and various modifications or changes may be made within the technical range. For example, the dual tuning fork piezoelectric vibrating reed in each of the embodiments described above may be changed to a piezoelectric vibrating reed including one vibrating beam. In addition, the thin wall section provided in the connecting section between the vibrating beam and the supporting section can function to change a frequency according to the direction of acceleration similar to the embodiments described above even if a groove is formed from both the top and bottom surface sides, as long as the thin wall section is asymmetrical with respect to the centerline in the thickness direction of the connecting section.

The entire disclosure of Japanese Patent Application No. 2009-249531, filed Oct. 29, 2009 and Japanese Patent Application No. 2010-237957, filed Oct. 22, 2010 are expressly incorporated by reference herein.

1. An acceleration sensor comprising:
a first sensitive element having a first vibrating beam, base ends located at both ends of the first vibrating beam in the longitudinal direction, and excitation electrodes which are formed on a surface of the first vibrating beam in order to excite the first vibrating beam in a bending vibration mode;
a supporting section connected to each of the base ends in order to support the first sensitive element;
a connecting section which is provided between one of the base ends and the supporting section so as to extend from the one base end in the opposite direction to the one base end on the same axis as the first vibrating beam and which has a thin section formed along the longitudinal direction of the first vibrating beam; and
a spindle section which is disposed at both sides of the first sensitive element in the width direction in a state of being connected to the one base end and extends toward the other base end side along the longitudinal direction.

2. The acceleration sensor according to claim 1, further comprising:
second and third sensitive elements symmetrically disposed at both sides of the spindle section in the width direction; and
second and third supporting sections for supporting the second and third sensitive elements, respectively,
wherein the second and third sensitive elements have second and third vibrating beams extending in parallel to the first vibrating beam along the spindle section, respectively, and
the second and third vibrating beams are connected to the adjacent spindle section at the base end located opposite the connecting section in the longitudinal direction and are connected to the second and third supporting sections at the base end located at a side of the connecting section in the longitudinal direction, respectively.

3. The acceleration sensor according to claim 1,
wherein the first sensitive element has the two first vibrating beams extending in parallel.

4. The acceleration sensor according to claim 1,
wherein the supporting section is formed by one supporting frame which surrounds the outside of the spindle section and the sensitive element.

5. The acceleration sensor according to claim 3,
wherein the supporting section is formed by one supporting frame which surrounds the outside of the spindle section and the sensitive element.

6. The acceleration sensor according to claim 2,
wherein the first sensitive element has the two first vibrating beams extending in parallel.

7. The acceleration sensor according to claim 2,
wherein the supporting section is formed by one supporting frame which surrounds the outside of the spindle section and the sensitive element.
